(19) United States
(12) Patent Application Publication
(10) Pub. No.: US 2010/0007276 A1
(43) Pub. Date: Jan. 14, 2010

(54) Ultra High Pressure Mercury Discharge Lamp

(75) Inventors: Naoki Goto, Yokohama (JP); Nobuyuki Konno, Yokohama (JP); Mitsuru Sato, Chiyoda-ku (JP); Toshimitsu Tanaka, Yokohama (JP)

Correspondence Address: COHEN, PONTANI, LIEBERMAN & PAVANE LLP, 551 FIFTH AVENUE, SUITE 1210, NEW YORK, NY, 10176, US

(73) Assignee: OSRAM Gesellschaft mit beschrankter Haftung, Munich (DE)

(21) Appl. No.: 12/482,271

(22) Filed: Jun. 10, 2009

(30) Foreign Application Priority Data
Jun. 10, 2008 (JP) 2008-152055

(51) Int. Cl. H01J 61/20

(52) U.S. Cl. 313/639

(57) ABSTRACT

A highly reliable ultra-high pressure mercury discharge lamp with a low risk of breakage of the quartz tube. The ultra-high pressure mercury discharge lamp includes a light emitting tube 2 in which a pair of electrode systems 24a, 24b is enclosed within a quartz tube. The pair of electrode systems 24a, 24b is outfitted with an electrode 21a, 21b having a weld 21a-2, 21b-2, a metal strip 22a, 22b with one end that is welded to the weld 21a-2, 21b-2, and a connection line 23a, 23b connected to the other end of the metal strip 22a, 22b. An aperture portion 22a-1, 22b-1 is provided in the metal strip 22a, 22b in the area surrounding the weld 21a-2, 21b-2.

### RELATED APPLICATIONS

This application claims the priority of Japanese patent application no. 2008-152055 filed Jun. 10, 2008.

### FIELD OF THE INVENTION

The present invention is directed to an ultra-high pressure mercury discharge lamp which is used as a light source for projectors and, more precisely, relates to the shape of the area surrounding the weld of the metal strip and electrode core wire of a light emitting tube.

### BACKGROUND OF THE INVENTION

In the light emitting tube of an ultra-high pressure mercury discharge lamp (also sometimes referred to hereinafter as “lamp”) which is used as a light source for projectors, electrode systems are inserted into the interior of a quartz glass tube and are tightly enclosed. The pressure in the interior part of a light emitting tube of an ultra-high pressure mercury discharge lamp is extremely high and can reach up to 200 atmospheres.

Therefore, the quartz tube of the light emitting tube may not be able to withstand the internal pressure when the lamp is switched on and may break. The adhesion between the quartz glass tube and metal strip is poor particularly at the weld of the electrode, and a gap develops therebetween. It may come about that mercury penetrates into this gap at high pressure and the quartz tube breaks.

FIG. 10 shows a cross-section through the light emitting tube 102 of a conventional ultra-high pressure mercury discharge lamp. The electrode system 124a and the electrode system 124b are arranged in pairs in the interior of the quartz tube 120 in the light emitting tube 102. The electrode system 124a is outfitted with the electrode 121a, the metal strip 122a and the connection line 123a. The interior of the light emitting tube 102 is filled with mercury 125 and noble gas. Further, the two edge portions of the light emitting tube 102 are closed in a sealing manner in that the quartz tube 120 is heated and fused.

FIG. 11 shows a cross section through the area surrounding the welds 121a-2 and 121b-2 after the conventional light emitting tube 102 has been sealed, namely, at right angles to the center line of the light emitting tube 102. When the cross-sectional shape of the welds 121a-2 and 121b-2 is circular, e.g., as is shown in FIG. 11, the area surrounding the connection points between the welds 121a-2, 121b-2 and the metal strips 122a, 122b is not reached by the quartz tube 120 during the process of sealing the light emitting tube 102, and the gap 126a results. When mercury 125 under high pressure penetrates into this gap 126a, there is a risk that the quartz tube 120 will break.

FIG. 12 shows a cross section through the area surrounding the weld 121b-2 after the conventional light emitting tube 102 has been sealed, namely, in direction of the center line of the light emitting tube 102. To ensure the stability of the fixed connection, the electrode 121b and the metal strip 122b are welded together in such a way that the edge portions of the metal strip 122b and of the substantially round electrode 121b overlap. Therefore, during the process of sealing the electrode system 124b, the gap 126b results (also in electrode system 124a) at the rectangular portion between the edge surface of the weld 121b-2 and the metal strip 122b as can be seen from FIG. 12.

When mercury 125 under high pressure penetrates into the gap 126b, the quartz tube 120 and the metal strip 122b may separate from one another. This separation takes place in the direction of the connection line 123b, and there is a risk that the quartz tube 120 will break.

### [Patent Document 1]. JP11-067156

As was described above with respect to a conventional ultra-high pressure mercury discharge lamp, in order to ensure the stability of the fixed connection, the electrodes 121a, 121b and the metal strips 122a, 122b are welded together in such a way that the metal strips 122a, 122b and the edge portions of the substantially round electrodes 121a, 121b overlap. Therefore, during the process of sealing the light emitting tube 102, gaps 126a, 126b result between the quartz tube 120 and metal strips 122a, 122b and electrodes 121a, 121b. When mercury 125 under high pressure penetrates into the gaps 126a, 126b, the quartz tube 120 and the metal strip 122a, 122b may separate from one another. This separation takes place in the direction of the connection lines 123a, 123b, and there is a risk that the quartz tube 120 will break.

### SUMMARY OF THE INVENTION

It is an object of the present invention to solve the problems mentioned above and to provide a highly reliable ultra-high pressure mercury discharge lamp with a low risk of breakage of the quartz tube.

This and other objects are attained in accordance with one aspect of the present invention directed to an ultra-high pressure mercury discharge lamp having a light emitting tube in which a pair of electrode systems is enclosed within a quartz tube. An electrode having a weld, a metal strip with one end that is welded to the weld, and a connection line connected to the other end of the metal strip are provided in the pair of electrode systems. An aperture portion is provided in the metal strip in the area surrounding the weld.

In an ultra-high pressure mercury discharge lamp according to an embodiment of the present invention, the aperture portion is provided in the area surrounding the edge portion of the weld.

In an ultra-high pressure mercury discharge lamp according to an embodiment of the present invention, the front edge of the weld is arranged in such a way that it is located opposite to the aperture portion of the metal strip.

In an ultra-high pressure mercury discharge lamp according to an embodiment of the present invention, the width L1 of the aperture portion is at most 70% of the width L0 of the metal strip.

In an ultra-high pressure mercury discharge lamp according to an embodiment of the present invention, the ratio between the diameter D of the weld of the electrode and the width L1 of the aperture portion is D≦L1≦3D.

In an ultra-high pressure mercury discharge lamp according to an embodiment of the present invention, a plurality of aperture portions are arranged in the metal strip in the area surrounding the weld of the electrode.

In an ultra-high pressure mercury discharge lamp according to an embodiment of the present invention, a U-shaped aperture portion is provided at the metal strip such that it encloses the weld of the electrode.

In an ultra-high pressure mercury discharge lamp according to an embodiment of the present invention, the separation can be prevented from progressing along the metal strip toward the connection line in that an aperture portion is provided in the metal strip in the area surrounding the weld because the quartz tube adheres internally through the aperture portion after sealing, even when the quartz tube and metal strip are separated from one another with the gap as starting point. Consequently, breakage of the light emitting tube can be prevented when switched on.

In an ultra-high pressure mercury discharge lamp according to an embodiment of the present invention, the gap present in conventional ultra-high pressure mercury discharge lamps at the rectangular portion between the edge surface of the weld and the metal strip can be eliminated in that the aperture portion is provided in the area surrounding the edge portion of the weld. Further, the gap occurring at the lateral portion of the weld of the electrode is not eliminated but, because the quartz tube adheres internally through the aperture portion after sealing, the separation along the metal strip toward the connection line can be prevented from progressing even when the quartz tube and metal strip are separated from one another with the gap as starting point.

In an ultra-high pressure mercury discharge lamp according to an embodiment of the present invention, the gap present in conventional ultra-high pressure mercury discharge lamps at the rectangular portion between the edge surface of the weld and the metal strip can be eliminated in a dependable manner in that the front edge of the weld is arranged in such a way that it lies opposite to the aperture portion of the metal strip.

In an ultra-high pressure mercury discharge lamp according to an embodiment of the present invention, high current density and an elevated temperature in the metal strip can be suppressed in that the width L1 of the aperture portion is at most 70% of the width L0 of the metal strip.

In an ultra-high pressure mercury discharge lamp according to an embodiment of the present invention, high current density and an elevated temperature in the metal strip can be suppressed in that the ratio between the diameter D of the weld of the electrode and the width L1 of the aperture portion is D≦L1≦3D. Further, the impairment of the effect whereby the separation of the quartz tube and metal strip is prevented from progressing along the metal strip toward the connection line with the gap as starting point as in conventional ultra-high pressure mercury discharge lamps can be kept to a minimum.

In an ultra-high pressure mercury discharge lamp according to an embodiment of the present invention, the gaps present in conventional ultra-high pressure mercury discharge lamps at both lateral portions of the weld and the gap at the rectangular portion between the edge surface of the weld and the metal strip are prevented in that a plurality of aperture portions are arranged in the metal strip in the area surrounding the weld of the electrode. Further, since the quartz tube adheres internally to the plurality of aperture portions, the separation of the quartz tube and metal strip can be prevented from progressing along the metal strip toward the connection line with the gap as starting point.

In an ultra-high pressure mercury discharge lamp according to an embodiment of the present invention, the gaps present in conventional ultra-high pressure mercury discharge lamps at the two lateral portions of the weld and the gap present in these lamps at the rectangular portion between the end surface of the weld and the metal strip are eliminated in that a U-shaped aperture portion is provided at the metal strip in such a way that it encloses the weld of the electrode. Further, since the quartz tube adheres internally through the aperture portion even when a tiny gap occurs, the separation of the quartz tube and metal strip with the gap as starting point can be prevented from progressing along the metal strip toward the connection line.

### BRIEF DESCRIPTION OF THE DRAWINGS

FIG. 1 shows an embodiment of the invention, and is a side view of the discharge lamp with reflection mirror 100 in partial section;

FIG. 2 shows a section of the light emitting tube 2 of FIG. 1;

FIG. 3 shows an outline of the metal strip 22b of FIG. 1;

FIG. 4 shows a partial outline of the electrode system 24b of FIG. 1;

FIG. 5 shows a section in direction of the center line of the light emitting tube 2 in the area surrounding the weld 21b-2 after the light emitting tube 2 has been sealed;

FIG. 6 shows an outline of the metal strip 22b of the example of a modified shape 1;

FIG. 7 shows an outline of the metal strip 22b of the example of a modified shape 2;

FIG. 8 shows an outline of the metal strip 22b of the example of a modified shape 3;

FIG. 9 shows an outline of the metal strip 22b of the example of a modified shape 4;

FIG. 10 shows a sectional view of the light emitting tube 102 of a conventional ultra-high pressure mercury discharge lamp;

FIG. 11 is a sectional view perpendicular to the center line of the light emitting tube 102 of FIG. 10 in the area surrounding the welds 121a-2 and 121b-2 after the sealing of a conventional light emitting tube 102; and

FIG. 12 is a sectional view in direction of the center line of the light emitting tube 102 in the area surrounding the weld 121b-2 after the sealing of a conventional light emitting tube 102.

### DETAILED DESCRIPTION OF THE DRAWINGS

The first embodiment is characterized by the shape of the metal strip arranged in the interior of the light emitting tube 2 in the area surrounding the weld of the electrode. The overall construction of the discharge lamp with reflection mirror 100 (an example of an ultra-high pressure mercury discharge lamp) will be explained in a simple manner in the following discussion.

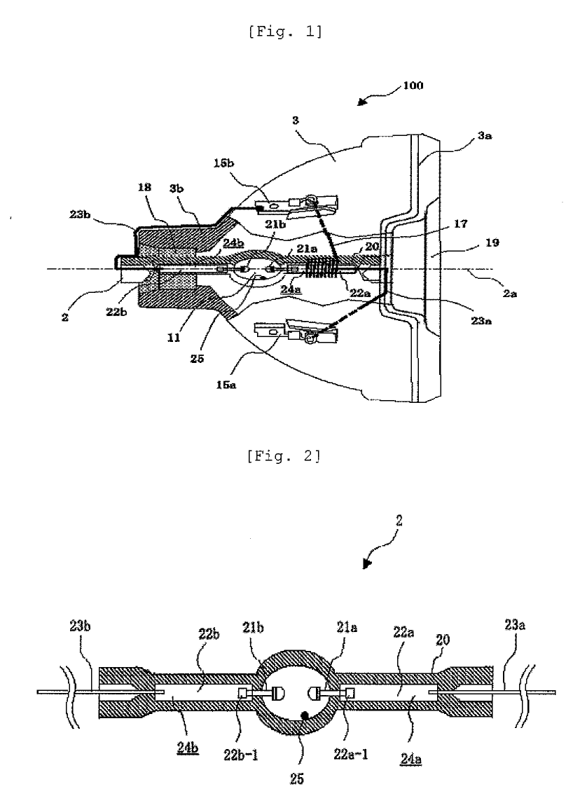

As is shown in FIG. 1, in the discharge lamp with reflection mirror 100, the light emitting tube 2 is contained in the interior of the reflection mirror 3 (a parabolic mirror type is shown in the example in FIG. 1). The light emitting tube 2 is fastened to the neck part 3b of the reflection mirror 3 by cement 18. The center axis 2a of the light emitting tube 2 coincides with the center axis connecting the aperture portion 3a and the neck part 3b of the reflection mirror 3 and it is fixed in such a way that the center of the light emitting part 11 is at the focus of the reflection mirror 3. The main constituent of the cement 18 is silica.

The light emitting tube 2 will be described in the following, but the connection line 23a connected to the electrode 21a of the electrode system 24a of the light emitting tube 2 is pulled out from the lateral edge surface of the front side of the light emitting tube 2 (side of the aperture portion 3a of the reflection mirror 3). The connection line 23a is connected to the first pole terminal 15a.

Further, the connection line 23b connected to the electrode 21b of the electrode system 24b of the light emitting tube 2 is pulled out from the lateral edge surface of the rear side of the light emitting tube 2 (side of the neck part 3b of the reflection mirror 3). The connection line 23b is connected to the second pole terminal 15b.

The trigger coil 17 is wound around the part covering the area surrounding the molybdenum strip 22a of the quartz tube 20. The trigger coil 17 is connected to the second pole terminal 15b.

The transparent front glass 19 is arranged at the aperture portion 3a of the front side of the reflection mirror 3.

The center of the light-emitting part 11 of the light emitting tube 2 is positioned in the focus of the reflection mirror 3 which has the shape of a shell, e.g., spherical, elliptical, parabolic, etc. The emitted light is reflected by a reflection diaphragm provided on the inner surface of the reflection mirror 3 and is emitted toward the front side of the lamp. The emitted light impinges in the optical system provided on the front side of the lamp.

The construction of the light emitting tube 2 will be described with reference to FIG. 2. Electrode system 24a and electrode system 24b are arranged by pairs in the interior of the quartz tube 20 in the light emitting tube 2. The electrode system 24a is outfitted with electrode 21a, metal strip 22a and connection line 23a. Electrode system 24b is likewise outfitted with electrode 21b, metal strip 22b and connection line 23b. The interior of the light emitting tube 2 is filled with mercury 25 and noble gas. Further, the two edge portions of the light emitting tube 2 are sealed in that the quartz tube 20 is heated and fused.

The details are described in the following discussion, but the aperture portions 22a-1, 22b-1 at the metal strips 22a, 22b are provided with a rectangular shape in the area surrounding the edge portions of the electrodes 21a, 21b in this example.

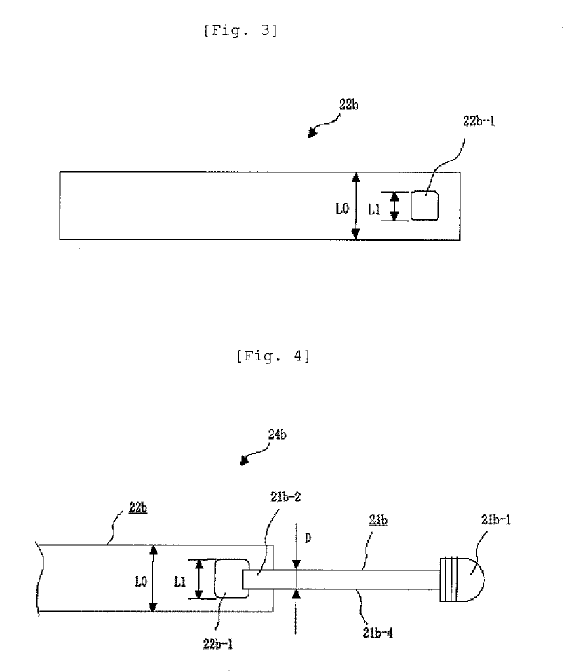

The construction of the metal strips 22a, 22b will be described with reference to FIG. 3. FIG. 3 shows an outline of the metal strip 22b, but metal strip 22a is symmetric to metal strip 22b.

The metal strips 22a, 22b comprise molybdenum and have a thickness of several dozen micrometers. The thin design of the metal strips 22a, 22b improves the adhesion to the quartz tube 20 and improves the tightness.

As is shown in FIG. 3, the metal strip 22b at the edge portion on the side where the electrode 21b is located is outfitted with the aperture portion 22b-1. This description refers to electrode system 24b but also applies to electrode system 24a.

In the example shown in FIG. 3, the aperture portion 22b-1 is rectangular. The width L1 (direction perpendicular to the longitudinal direction) of the aperture portion 22b-1 is at most 70% of the width L0 (direction perpendicular to the longitudinal direction) of the metal strip 22b. The reason for this will be explained in the following.

As is shown in FIG. 4, when the electrode 21b is welded to the metal strip 22b, the front edge of the weld 21b-2 of the electrode 21b is arranged in such a way that it is located opposite to the aperture portion 22b-1 of the metal strip 22b. However, it is also possible that the front edge of the weld 21b-2 of the electrode 21b is arranged in such a way that it coincides with the edge portion of the aperture portion 22b-1 of the metal strip 22b. Further, it is also possible that the front edge of the weld 21b-2 of the electrode 21b is arranged in such a way that it is at a distance from the edge portion of the aperture portion 22b-1 of the metal strip 22b toward the side on which the electrode 21b is located.

The diameter of the core wire 21b-4 (weld 21b-2) of the electrode 21b is designated by D. A range of

D≦L1≦3D (1)

is desirable for the width L1 of the aperture portion 22b-1.

When L1 is greater than 3D, the current density of the metal strip 22b is high and the temperature of the metal strip 22b is high.

For the same reason, the width L1 (direction perpendicular to the longitudinal direction) of the aperture portion 22b-1 should be at most 70% of the width L0 in the direction perpendicular to the longitudinal direction of the metal strip 22b.

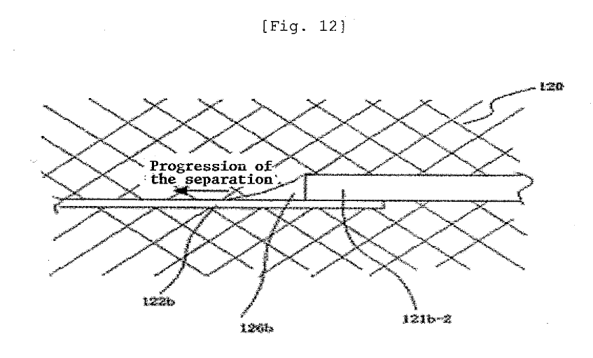

The electrode system 24b shown in FIG. 4 is introduced into the quartz tube 20 and, because the aperture portion 22b-1 at the metal strip 22b is open when the quartz tube 20 is heated and sealed, the gap 126b (see FIG. 12) occurring in conventional ultra-high pressure mercury discharge lamps at the rectangular portion between the edge surface of the weld 121b-2 and the metal strip 122b disappears.

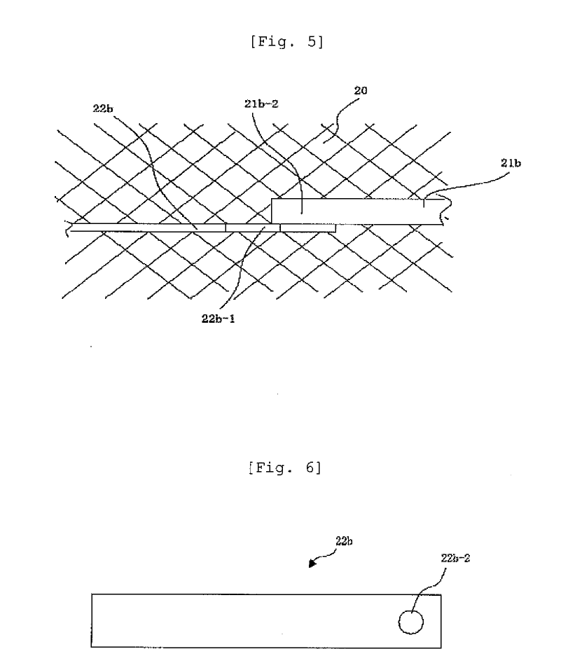

Due to the fact that the front edge of the weld 21b-2 of the electrode 21b is arranged in such a way that it lies opposite to the aperture portion 22b-1 of the metal strip 22b as is shown in FIG. 5, the gap 126b occurring in conventional ultra-high pressure mercury discharge lamps at the rectangular portion between the edge surface of the weld 121b-2 and the metal strip 122b can be reliably eliminated.

The gap 126a (see FIG. 11) occurring at the lateral portion of the weld 21b-2 of the electrode 21b is not eliminated. However, since the quartz tube 20 adheres internally through the aperture portion 22b-1 after sealing, the separation can be prevented from progressing along the metal strip 22b toward the connection line 23b even when the quartz tube 20 and metal strip 22b are separated from one another with the gap 126a as starting point. Consequently, breakage of the light emitting tube 2 can be prevented when switching on.

When L1 is less than D in equation (1), the gap 126b (see FIG. 12) present in conventional ultra-high pressure mercury discharge lamps at the rectangular portion between the edge surface of the weld 121b-2 and the metal strip 122b occurs to a slight extent. Further, the effect whereby the separation of the quartz tube 20 and metal strip 22b is prevented from progressing along the metal strip 22b toward the connection line 23b with the gap 126a as starting point is reduced.

The aperture portion 22b-1 of the metal strip 22b can also have a shape other than a rectangular shape. It can have any shape. Examples of shapes other than the rectangular shape are shown in the following.

FIG. 6 shows an example of an aperture portion 22b-2 with a circular shape. When the electrode 21b is welded to the metal strip 22b, the front edge of the weld 21b-2 of the electrode 21b is arranged in such a way that it lies opposite to the aperture portion 22b-2 of the metal strip 22b. However, it is also possible that the front edge of the weld 21b-2 of the electrode 21b is arranged in such a way that it coincides with the edge portion of the aperture portion 22b-2 of the metal strip 22b. Further, it is also possible that the front edge of the weld 21b-2 of the electrode 21b is arranged in such a way that it is at a distance from the edge portion of the aperture portion 22b-2 of the metal strip 22b toward the side on which the electrode 21b is located.

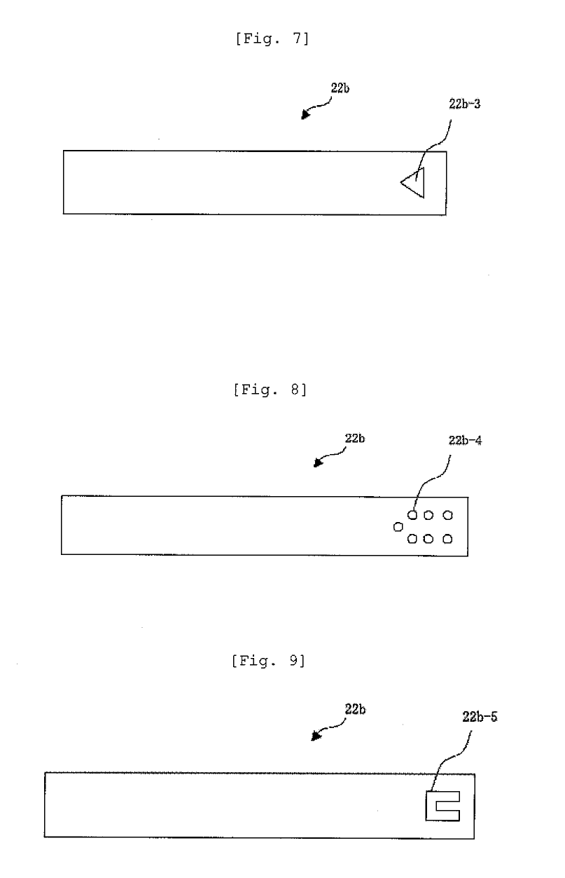

FIG. 7 shows an example of an aperture portion 22b-3 with a triangular shape. When the aperture portion 22b-3 is triangular, it is arranged in such a way that one of its sides extends substantially parallel to the width direction (direction perpendicular to the longitudinal direction) of the metal strip 22b. Accordingly, substantially the same effect is achieved as in the case of a rectangular aperture portion 22b-1.

Also, in case the aperture portion 22b-3 has a triangular shape, when the electrode 21b is welded to the metal strip 22b, the front edge of the weld 21b-2 of the electrode 21b is arranged in such a way that it lies opposite to the aperture portion 22b-3 of the metal strip 22b. However, it is also possible that the front edge of the weld 21b-2 of the electrode 21b is arranged in such a way that it coincides with the edge portion of the aperture portion 22b-3 of the metal strip 22b. Further, it is also possible that the front edge of the weld 21b-2 of the electrode 21b is arranged in such a way that it is at a distance from the edge portion of the aperture portion 22b-3 of the metal strip 22b toward the side on which the electrode 21b is situated.

As is shown in FIG. 8, a plurality of aperture portions 22b-4 can also be arranged in the metal strip 22b in the area surrounding the weld 21b-2 of the electrode 21b. In the example shown in FIG. 8, seven round aperture portions 22b-4 are provided.

The seven aperture portions 22b-4 are arranged at a determined distance from one another in such a way that one is located at the edge portion of the weld 21b-2 of the electrode 21b and three are located at each of the two lateral portions.

The diameter of the aperture portions 22b-4 is 0.1 to 0.5 mm.

Apart from the circular shape shown in FIG. 8, the aperture portions 22b-4 can have any shape, e.g., elliptical, rectangular, triangular, etc.

As is shown in FIG. 8, the gap 126a present in conventional ultra-high pressure mercury discharge lamps at both lateral portions of the weld 121b-2 and the gap 126b occurring in these lamps at the rectangular portion between the edge surface of the weld 121b-2 and the metal strip 122b are reduced in that a plurality of aperture portions 22b-4 are arranged in the area surrounding the weld 21b-2 of the electrode 21b in the metal strip 22b.

Further, the separation of the quartz tube 20 and metal strip 22b with the gaps 126a, 126b as starting point can be prevented from progressing along the metal strip 22b toward the connection line 23b in that the quartz tube 20 adheres internally through the plurality of aperture portions 22b-4.

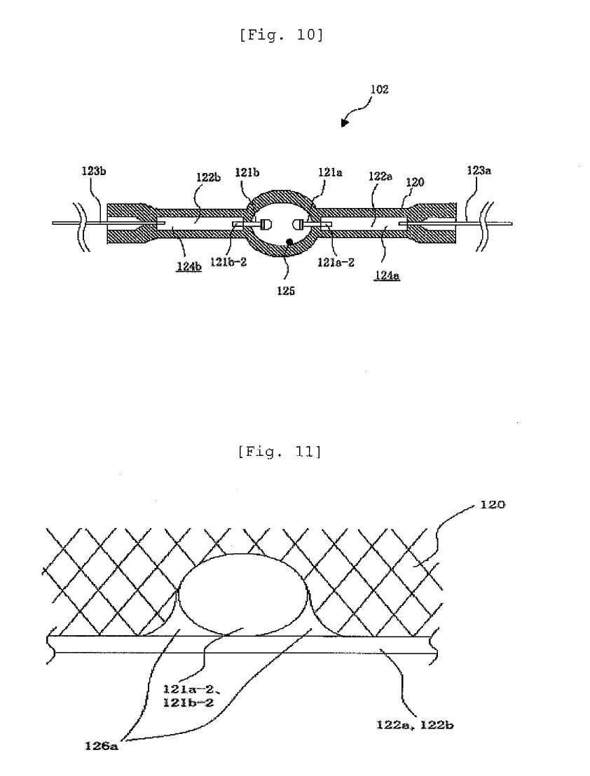

As is shown in FIG. 9, a U-shaped aperture portion 22b-5 can also be provided at the metal strip 22b in such a way that it encloses the weld 21b-2 of the electrode 21b.

The gap 126a present in conventional ultra-high pressure mercury discharge lamps at the two lateral portions of the weld 121b-2 and the gap 126b present in these lamps at the rectangular portion between the edge surface of the weld 121b-2 and the metal strip 122b disappear in that a U-shaped aperture portion 22b-5 is provided at the metal strip 22b in such a way that it encloses the weld 21b-2 of the electrode 21b.

Further, even when the gaps 126a, 126b occur to a slight extent, the separation of the quartz tube 20 and metal strip 22b with the gaps 126a, 126b as starting point can be prevented from progressing along the metal strip 22b toward the connection line 23b in that the quartz tube 20 adheres internally through the aperture portion 22b-5.

As is described above, this embodiment form makes it possible that the gap 126b present in conventional ultra-high pressure mercury discharge lamps at the rectangular portion between the edge surface of the welds 121a-1, 121b-2 and the metal strip 122a, 122b disappear in that the aperture portions 22a-1, 22b-1 having a rectangular, circular, triangular, or other shape are provided in the metal strips 22a, 22b in the area surrounding the edge portions of the electrodes 21a, 21b.

Further, the gap 126a (see FIG. 11) occurring at the lateral portions of the welds 21a-2, 21b-2 of the electrodes 21a, 21b is not eliminated but, since the quartz tube 20 adheres internally through the aperture portions 22a-1, 22b-1 after sealing, the separation can be prevented from progressing along the metal strips 22a, 22b toward the connection lines 23a, 23b even when the quartz tube 20 and metal strips 22a, 22b are separated from one another with the gap 126a as starting point. Consequently, breakage of the light emitting tube 2 can be prevented when switching on.

A high current density of the metal strips 22a, 22b and a high temperature of the metal strips 22a, 22b can be suppressed in that the ratio between the diameter D of the core wires 21a-4, 21b-4 of the electrodes 21a, 21b and the width L1 of the aperture portions 22a-1, 22b-1 is D≦L1≦3D. Further, the prevention of the effect whereby the separation of the quartz tube 20 and metal strip 22b is prevented from progressing along the metal strip 22b toward the connection line 23b with the gap 126a as starting point as in conventional ultra-high pressure mercury discharge lamps can be kept to a minimum.

Further, high current density of the metal strips 22a, 22b and high temperature of the metal strips 22a, 22b can be suppressed in that the width L1 of the aperture portion 22b-1 is at most 70% of the width L0 of the metal strip 22b.

Further, the gap 126a present in conventional ultra-high pressure mercury discharge lamps at both lateral portions of the welds 121a-2, 121b-2 and the gap 126b present in these lamps at the rectangular portion between the edge surface of the welds 121a-2, 121b-2 and the metal strips 122a, 122b are reduced in that a plurality of circular aperture portions 22a-4, 22b-4 with a diameter of 0.1 to 0.5 mm are arranged in the area surrounding the welds 21a-2, 21b-2 of the electrodes 21a, 21b in the metal strips 22a, 22b. Further, since the quartz tube 20 adheres internally through the plurality of aperture portions 22a-4, 22b-4, the separation of the quartz tube 20 and metal strips 22a, 22b with the gaps 126a, 126b as starting point is prevented from progressing along the metal strips 22a, 22b toward the connection lines 23a, 23b.

Further, the gap 126a present in conventional ultra-high pressure mercury discharge lamps at the two lateral portions of the welds 121a-2, 121b-2 and the gap 126b present in these lamps at the rectangular portion between the edge surfaces of the welds 121a-2, 121b-2 and the metal strips 122a, 122b disappear in that U-shaped aperture portions 22a-5, 22b-5 are provided at the metal strips 22a, 22b in such a way that they enclose the welds 21a-2, 21b-2 of the electrodes 21a, 21b.

Further, even when the gaps 126a, 126b occur to a slight degree, the separation of the quartz tube 20 and metal strips 22a, 22b with the gaps 126a, 126b as starting point can be prevented from progressing along the metal strips 22a, 22b toward the connection lines 23a, 23b in that the quartz tube 20 adheres internally through the aperture portions 22a-5, 22b-5.

The scope of protection of the invention is not limited to the examples given hereinabove. The invention is embodied in each novel characteristic and each combination of characteristics, which includes every combination of any features which are stated in the claims, even if this feature or combination of features is not explicitly stated in the examples.

We claim:

1. An ultra-high pressure mercury discharge lamp having a light emitting tube in which a pair of electrode systems is enclosed within a quartz tube;
wherein an electrode having a weld, a metal strip with one end welded to said weld, and a connection line connected to the other end of said metal strip are arranged in said pair of electrode systems; and
wherein an aperture portion is arranged in said metal strip in the area surrounding said weld.

2. The ultra-high pressure mercury discharge lamp according to claim 1, wherein said aperture portion is arranged in the area surrounding the edge portion of said weld.

3. The ultra-high pressure mercury discharge lamp according to claim 2, wherein the front edge of said weld is arranged in such a way that it is located opposite to said aperture portion of said metal strip.

4. The ultra-high pressure mercury discharge lamp according to claim 1, wherein the width L1 of said aperture portion is at most 70% of the width L0 of said metal strip.

5. The ultra-high pressure mercury discharge lamp according to claim 1, wherein the ratio between the diameter D of said weld of said electrode and the width L1 of said aperture portion is D≦L1≦3D.

6. The ultra-high pressure mercury discharge lamp according to claim 1, wherein a plurality of said aperture portions are arranged in said metal strip in the area surrounding said weld of said electrode.

7. The ultra-high pressure mercury discharge lamp according to claim 1, wherein said aperture portion having a U-shape is arranged at said metal strip such that it encloses said weld of said electrode.
